(19) United States
(12) Patent Application Publication
(10) Pub. No.: US 2014/0268554 A1
(43) Pub. Date: Sep. 18, 2014

(54) Stackable Computing System

(71) Applicant: BIRCHBRIDGE INCORPORATED, Belmont, CA (US)

(72) Inventors: John Craig Dunwoody, Belmont, CA (US); Teresa Ann Dunwoody, Belmont, CA (US)

(73) Assignee: BIRCHBRIDGE INCORPORATED, Belmont, CA (US)

(21) Appl. No.: 13/844,863

(22) Filed: Mar. 16, 2013

(51) Int. Cl. G06F 1/20

(52) U.S. Cl. CPC G06F 1/206
USPC 361/679.54

(57) ABSTRACT

Systems and methods providing for stackable rack-based computing systems are discussed herein. A stackable rack-based computing system may include a plurality of stackable shelf frames. Each stackable shelf frame may include a module and one or more cooling elements to cool the module from a first side. The stackable shelf frames may be adjustable between an open configuration and a stacked configuration. In the stacked configuration, where the stackable shelf frames are stacked on top of each other, the modules may receive cooling from a second side from an adjacent stackable shelf frame. In the open configuration, a gap may be opened between any two of the plurality of stackable shelf frames for service and maintenance tasks.

### FIELD

Embodiments of the invention relate, generally, to scalable packaging for computing systems.

### BACKGROUND

Circuitry can be configured to perform data networking, processing, storage, and/or other types of functionality. Often, such circuitry, referred to herein as “components,” is installed in computing racks that provide packaging, power, networking and cooling to the computing components. The design of rack based computing systems may require various tradeoffs in areas such as space efficiency (e.g., usable networking, processing, and/or storage capacity per unit of volume and/or floor area occupied by a computing rack), energy efficiency, cost, scalability, and serviceability. In this regard, areas for improving current systems have been identified.

### BRIEF SUMMARY

Through applied effort, ingenuity, and innovation, solutions to improve such systems have been realized and are described herein. Systems are provided to, in general, improve rack based computing systems. More specifically, systems and methods providing for stackable rack-based computing systems are discussed herein. A stackable rack-based computing system may include a plurality of stackable shelf frames. Each stackable shelf frame may include a module and one or more cooling elements to cool the module from a first side. The stackable shelf frames may be adjustable between an open configuration and a closed configuration. In the closed configuration, where the stackable shelf frames are stacked on top of each other, the modules may receive cooling from a second side from an adjacent stackable shelf frame. In the open configuration, a gap may be opened between any two of the plurality of stackable shelf frames for service and maintenance tasks.

Some embodiments may provide for a stackable rack-based computing system that includes a plurality of shelf frames, each stackable shelf frame including: a module including a top side and a bottom side; one or more cooling elements thermally coupled to one of the top side and the bottom side of the module; and a frame configured to mechanically couple the module and the one or more module cooling elements. The plurality of stackable shelf frames may be adjustable between a stacked configuration and an open configuration.

In the stacked configuration, at least one module (e.g., and up to all modules, in a various embodiments) of a stackable shelf frame of the plurality of stackable shelf frames may be thermally coupled with cooling elements at the top side and the bottom side of the module. In the open configuration, a gap may be open between any two of the plurality of stackable shelf frames.

In some embodiments of the stackable rack-based computing system, each of the plurality of stackable shelf frames may include two or more frame spacers. The plurality of stackable shelf frames may be stacked on top of each other via the two or more frame spacers of each of the plurality of stackable shelf frames in the closed configuration. In some embodiments, the two or more frame spacers of each of the plurality of stackable shelf frames may each configured to conform to a standard distance of height.

In some embodiments, the stackable rack-based computing system may also include two or more rack poles each received by a rack pole hole of one of the two or more frame spacers of each of the plurality of stackable shelf frames. The two or more rack poles may uniformly move along a length dimension L of the two or more rack poles. Each of the plurality of stackable shelf frames may be mechanically coupled to the two or more rack poles such that movement of the two or more rack poles may also moves a mechanically coupled stackable shelf frame of the plurality of stackable shelf frames, thereby adjusting the plurality of stackable shelf frames between the stacked configuration and the open configuration.

In some embodiments, the two or more rack poles may include pin holes for receiving a pin. Each of the two or more frame spacers of each of the plurality of stackable shelf frames includes frame pin holes for receiving the pin. The distance between any two of the pole pin holes may conform to the standard distance of height.

In some embodiments, the each of the two or more frame spacers of at least one of the plurality of stackable shelf frames are U-shaped spacers. For example, U-shaped spacers and spacers of other shapes providing similar functionality may facilitate individual removal and/or addition of the stackable shelf frames from the stackable rack-based computing system.

In various embodiments, the cooling elements thermally coupled to the module of each stackable shelf frame may be heat pipes and/or cooling plates. The rack-based computing system may further include one or more cooling tanks thermally coupled to the cooling elements. For example, the cooling elements may cool the module and the cooling tanks may cool the cooling elements and may also facilitate the transfer of collected heat away from the rack-based computing system, such as to an external cooling fluid source.

In some embodiments, at least one module of a stackable shelf frame of the plurality of shelf frames may be a networking module configured to provide at least one of passive network interconnection and active network switching for other modules of the plurality of stackable shelf frames.

In some embodiments, the module is a marina brain board assembly. In some embodiments, the module may include one or more two-sided printed circuit boards that defines the top side and the bottom side of the module. The one or more components may be disposed on each side of the one or more two-sided printed circuit boards and thermally coupled with cooling elements at the top side and the bottom side of the module in the stacked configuration. The one or more components disposed on each side of the one or more two-sided printed circuit boards may be in physical contact with the cooling elements at the top side and the bottom side of the module in the stacked configuration. In some embodiments, the one or more two-sided printed circuit boards may be one or more boat lobe boards removably connected with a pier board for power and networking.

In some embodiments, the module may further include a boardwalk board and a network switch board configured to provide network functionality to the module. The network switch board may be removably connected to the module via the boardwalk board. In some embodiments, the module may include a boardwalk board and a boardwalk power board configured to provide power to the module. The boardwalk power board removably connected to the module via the boardwalk board. In one example, a single boardwalk board may be removably connected with one or more network switch boards and one or more boardwalk power boards.

Some embodiments may provide for a stackable rack-based processing system that includes a plurality of shelf frames. Each shelf frame may include: a module including a two-sided printed circuit board, the two-sided printed circuit board defining a top side and a bottom side of the module; a cooling element thermally coupled to one of the bottom side and the top side of the module; and two or more frame spacers each including a rack pole hole. The stackable rack-based processing system may further include two or more rack poles, each within the rack pole hole of a respective one of the two or more frame spacers of each of the plurality of stackable shelf frames such that: the two or more rack poles may move independently of the plurality of stackable shelf frames; and the two or more rack poles can be mechanically coupled to one or more of the plurality of stackable shelf frames such that the one or more of the plurality of stackable shelf frames move with the two or more rack poles.

Some embodiments may provide for a stackable-rack based computing system, including a plurality of stackable shelf frames including a first stackable shelf frame. The first stackable shelf frame may include: a module including a two-sided printed circuit board, the two-sided printed circuit board including a top side and a bottom side of the module; one or more heat pipes thermally coupled to one of the bottom side and the top side of the module; two or more frame spacers each including a rack pole hole; a cooling tank thermally coupled to the heat pipes. The stackable-rack based computing system may further include two or more rack poles, each within the rack pole hole of a respective one of the two or more frame spacers of each of the plurality of stackable shelf frames. The two or more rack poles can be mechanically coupled to one or more of the plurality of stackable shelf frames such that the one or more of the plurality of stackable shelf frames may move with the two or more rack poles.

These characteristics as well as additional features, functions, and details of various corresponding and additional embodiments, are also described below.

### BRIEF DESCRIPTION OF THE DRAWINGS

Having thus described some embodiments in general terms, reference will now be made to the accompanying drawings, which are not necessarily drawn to scale, and wherein:

FIG. 1a shows a front view of an example stackable rack-based computing system, in accordance with some embodiments;

FIG. 1b shows a back view of an example stackable rack-based computing system, in accordance with some embodiments;

FIG. 1c shows a side view of an example stackable rack-based computing system, in accordance with some embodiments;

FIG. 1d shows a cross sectional top view of an example stackable rack-based computing system, in accordance with some embodiments;

FIG. 1e shows an example stackable shelf frame, in accordance with some embodiments;

FIGS. 2a and 2b show an example network module, configured in accordance with some embodiments;

FIG. 3 shows a front view of an example stackable rack-based computing system in an open configuration, in accordance with some embodiments;

FIG. 4 shows an example stackable shelf frame and rack poles, in accordance with some embodiments;

FIG. 5 shows another example of a stackable shelf frame, in accordance with some embodiments;

FIG. 6 shows a cross sectional top view of an example stackable rack-based computing system, in accordance with some embodiments;

FIGS. 7a and 7b show example frame spacers, in accordance with some embodiments;

FIG. 8 shows an example marina brain board assembly, configured in accordance with some embodiments;

FIGS. 9a and 9b show an example boat lobe board, configured in accordance with some embodiments;

FIG. 10 shows a cross sectional top view of an example stackable rack-based computing system including a marina brain board assembly, in accordance with some embodiments;

FIG. 11 shows another example of a marina brain board assembly, configured in accordance with some embodiments;

FIG. 12 shows an example of a brain board assembly, configured in accordance with some embodiments;

FIG. 13 shows a cross sectional top view of a computing system that includes a thermal backplane, in accordance with some embodiments;

FIG. 14 shows a cross sectional top view of a computing system that includes a cooling plate, in accordance with some embodiments; and

FIG. 15 shows a front view of an example stackable rack-based computing system, in accordance with some embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

Some embodiments discussed herein may provide for a stackable rack-based computing system. For example, the stackable rack-based computing system may house numerous components (e.g., in groups of the components, referred to herein as “modules”) that are interconnected to perform data processing, storage and networking functionality. In some embodiments, the components may include basic computing elements such as processors (e.g., a system on chip (SoC)), memory, network routers, or the like. The stackable rack-based computing system may be configured to provide packaging for the components in a scalable and space efficient manner while also delivering mechanical protection, thermal cooling, power, and/or networking to the components.

In some embodiments, the stackable rack-based computing system may include a plurality of stackable shelf frames. Each stackable shelf frame may house a module. During the course of operation, the stackable shelf frames may be stacked on top of each other in a “stacked configuration,” as used herein, such that each module within each stackable shelf frame receives two-sided cooling. The cooling may be provided by any suitable means. For example, cooling elements such as heat pipes or cooling plates may be coupled to each stackable shelf frame to provide module cooling from a first side (e.g., the bottom). Here, a module of a stackable shelf frame may be cooled from a second side (e.g., the top) by an adjacently stacked stackable shelf frame.

Some embodiments may provide for enhanced serviceability and space efficiency. For example, the stackable rack-based computing system may be configured such that a selectable gap may be held open between any two stackable shelf frames. An “open configuration,” as used herein, refers to a configuration of the rack-based computing system where the selectable gap is opened between any two stackable shelf frames. The gap may be used to provide access to the modules, power and networking connections, cooling elements, components of the module, etc. for purposes such as installation, repair, replacement, removal, configuration, troubleshooting, upgrades, or the like. Once service is completed, the stackable rack-based computing system may be configured such that the selectable gap may be closed so that the stackable shelf frames are stacked on top of each other (e.g., to provide two-sided cooling to each module). In some embodiments, the stackable shelf frames may be configured to facilitate individual addition or removal of the stackable shelf frames as desired (e.g., to increase and/or decrease the number of modules).

Some embodiments may further provide for modules having components that are disposed and/or interconnected for space efficiency, two-sided cooling and serviceability. For example, the module may include one or more two-sided printed circuit board (PCB) having components disposed on both sides. In the stacked configuration, components on the first side of the PCB may thermally couple and/or physically contact a first cooling element, and components on the second side of the PCB may thermally couple and/or physically contact with a second cooling element. The resulting stacked, repeating configuration of cooling element, component, PCB, component, and cooling element, may provide two-sided cooling at the PCB level for each module with little wasted space, allowing for greater component density within the stackable rack-based computing system.

FIGS. 1a, 1b and 1c show a front view, a back view and a side view, respectively, of an example stackable rack-based computing system 100 (or computing system 100), configured in accordance with some embodiments. Computing system 100 may include a plurality of stackable shelf frames 102, such as stackable shelf frame 102a, stackable shelf frame 102b, and stackable shelf frame 102c shown in FIG. 1a. Although fourteen stackable shelf frames 102 are shown, computing system 100 may include any number of stackable shelf frames in various embodiments. For example, some embodiments of computing system 100 may include 128 stackable shelf frames.

Stackable shelf frame 102a, like some or all of the other stackable shelf frames 102, may include a module 104a and one or more cooling elements 106a. Cooling elements 106a may be configured to thermally couple to module 104 to remove heat from a first side (e.g., the bottom) of module 104a. In FIGS. 1a, 1b and 1c, stackable shelf frames 102 are stacked on top of each other such that computing system 100 may be referred to as being in the stacked configuration (e.g., versus the open configuration). For example and with reference to FIG. 1a, stackable shelf frame 102b may be stacked on top of stackable shelf frame 102a. Stackable shelf frame 102b may also include one or more cooling elements 106b that provide cooling from the first side (e.g., the bottom) to module 104b. Via the stacking, cooling elements 106b may further provide cooling from a second side (e.g., the top) of module 104a of stackable shelf frame 102. As such, computing system 100 may provide two-sided cooling to module 104a, as well as to some or all of the other modules 104.

In some embodiments, such as when cooling elements 106 are heat pipes, computing system 100 may further include a plurality of cooling tanks 108, for example, as shown by cooling tanks 108a, 108b and 108c in FIGS. 1a and 1c. Cooling tanks 108 may be made of metal, plastic, and/or any other suitable material and be single-phase liquid heat exchangers in some embodiments. In some embodiments, cooling tanks 108b may be also be designed to contribute structural strength to the stackable rack-based computing system, in some cases in lieu of single-purpose design elements for providing structural strength. With reference to FIG. 1c, cooling tank 108a may include inlet 112a and outlet 114a for respectively inputting and outputting a cooling fluid, such as water, a mixture of water with other liquids, refrigerant, and/or other cooling fluids not containing any water. The cooling fluid may flow through cooling tank 108a and absorb heat (e.g., generated by the module(s)) from cooling elements 106a. Inlet 112a and/or outlet 114a may be connected to an external cooling fluid source. In another example, inlet 112a and/or outlet 114a may be connected with another cooling source. For example, inlet 112b of cooling tank 108b may be connected with the external cooling fluid source, inlet 112a may be connected with outlet 114b, outlet 114a may be connected with inlet 112c of cooling tank 102c, and outlet 114c may be connected with the external cooling fluid source. As such, cooling fluid may be cooled by the external cooling fluid source, flow through one or more cooling tanks to cool modules 104, and return to the external cooling fluid source.

Cooling tanks 108 may include cooling tank holes 116 in which liquid condensing portions of the of cooling elements 106 (or, “heat pipes 106”) may be inserted for thermal coupling with cooling tanks 108. FIG. 1d shows a cross sectional view of computing system 100 taken along line AA shown in FIG. 1a. Here, heat pipe 106a may include a relatively flat liquid boiling portion 120 configured to thermally couple with module 104a. Heat pipe 106a may also include liquid condensing portions 119 each configured to be inserted into a tank hole 116 and to thermally couple with cooling tank 108a. Heat pipe 106a may include one or more hollow cavities in which liquid, such as water, may be contained. Via heating from module 104a, the liquid may boil at liquid boiling portion 120 and evaporate to liquid condensing portions 119. At liquid condensing portions 119, the vaporized liquid may be cooled by cooling tank 108a and condensed back to liquid form. In some embodiments, the interior cavity at liquid condensing portions 119 may include a shape for maximizing surface area and condensation (e.g., as shown by cross section 306 of an example liquid condensing portion of a heat pipe in FIG. 1c)

In some embodiments, the boiling portion 120 of each heat pipe 106a on the left side of FIG. 1d, may be joined seamlessly with the boiling portion 120 of the corresponding heat pipe 106a on the right side of FIG. 1d, forming a single unified heat pipe 106a that is thermally coupled with cooling tank 108a on the left side of FIG. 1d, and also simultaneously with separate cooling tank 108a on the right side of FIG. 1d. The cooling source connected to the left-side cooling tank 108a, may be independent from the cooling source connected to the right-side cooling tank 108a. In this case, if one of these two cooling sources fails or is temporarily disabled (e.g. for maintenance), the unified heat pipe 106a may continue to provide effective cooling, because the unified heat pipe 106a may continue to be thermally coupled to one cooling tank 108a that may be connected to a still-functioning cooling fluid source. Additionally, in some embodiments, sealing features may be added to help protect components from damage caused by liquid contact in case of leakage from cooling tanks 108 and/or related plumbing. Some example sealing features may include double-wall construction of cooling tanks 108 and/or a watertight containment barrier that separates stackable shelf frames 102 from cooling tanks 108, and may be penetrated only by heat pipes 106, at the locations where the liquid condensing portions 119 of heat pipes 106 enter tank holes 116.

As shown in FIG. 1a, heat pipe 106a may be disposed such that liquid boiling portion 120 may be lower to the ground than liquid condensing portions 119 (e.g., in the stacked configuration), such that the vaporized liquid may rise to liquid condensing portions 119 and the condensed liquid may drop to liquid boiling portion 120. In some embodiments, tank holes 116 may include one or more copper sleeves and/or thermal interface materials, to increase heat transfer from heat pipes 106a.

In some embodiments, each stackable shelf frame 102 may be configured to conform to a standard distance of height, or “pitch” (P), as shown in FIG. 1a. For example, the standard distance of height may be 0.5 inches such that each stackable shelf frame defines a 0.5 inch height. As such, two stackable shelf frames may collectively define a 1 inch height or a factor of two of the standard distance of height (2P). Modules 104, cooling elements 106 and/or cooling tanks 108 may also be designed to conform to the standard distance of height. For example, the combined thickness of a module 104a and a cooling element 106a may also conform to the standard distance of height (e.g., by a factor of one or some other factor that matches the factor of the stackable shelf frame 102a). In some embodiments, the heat-dissipating surfaces on the top and/or bottom of a module 104a might be treated with one or more layers of conformable Thermal Interface Materials (TIM), such as compressible thermally-conductive foam blocks, sponges, pads, putties, gap-fillers, and/or other materials. This TIM may help improve the efficiency of waste-heat transfer from module 104a to adjacent cooling elements 106a. If present, this TIM may cause the combined thickness of a module 104a and adjacent cooling elements 106a, to exceed the thickness of a stackable shelf frame 102a, when a stackable rack-based computing system is in an open configuration and/or the TIM is in an uncompressed state. The TIM may be designed to compress such that when the stackable rack-based computing system is in a stacked configuration, the TIM provides peak heat-transfer capability, and the combined thickness of module 104a (including TIM) and adjacent cooling components 106a exactly matches the thickness of the stackable shelf frame 102a. Furthermore, cooling tank 108a may conform to the standard distance of height by a factor of four and cooling tanks 108b and 108c may conform to the standard distance of height by a factor of five. In some embodiments, one or more of cooling tanks 108 may also conform to the standard distance of height by a factor of one or some other factor that matches a factor of a stackable shelf frame.

FIG. 1e shows another view of stackable shelf frame 102a, in accordance with some embodiments. While FIGS. 1d and 1e are discussed with respect to stackable shelf frame 102a, the discussion may also be applicable to other stackable shelf frames 102. Stackable shelf frame 102a may include a frame 150 and frame spacers 152. Frame 150 may define (e.g., in dimension, shape, design, etc.) a module receiving area 154 (shown in outline) in which a module, such as module 104a, may be removably inserted. Once inserted, module 104a may receive cooling at its bottom surface by cooling elements 106a, which may be also coupled to frame 150 (as shown in FIG. 1b). Frame 150 may further include one or more module stabilizing beams 156 for stabilizing or otherwise keeping the module 104 in place within frame 150.

In some embodiments, stackable shelf frame 102a may further include power connector 158 and network connector 160 for respectively providing power and networking to module 104a, as shown in FIGS. 1d and 1 e. Power connector 158 may include a first interface that receives power from power distribution unit 162 and a second interface (e.g., shown at 158a in FIG. 1e) that transmits the received power to module 104a (e.g., via a module power connector of module 104a, an example of which is shown in FIG. 8 as module power connector 822). Power distribution unit 162 may receive power from an external source and convert the power to a format suitable for power connector 158. For example, power distribution unit 162 may convert a received 3-phase 480 Vrms AC source into a 1-phase 277 Vrms AC voltage source for each module. One of the 1-phase 277 Vrms AC voltage sources may be sent to power connector 158. In other embodiments, power distribution unit 162 may be configured to provide a DC voltage source, such as 360 V DC, for each module. As shown in the back view of computing system 100 in FIG. 1b, power distribution module 162 may be disposed along the height of computing system 100. Power distribution module 162 may receive external power at 164 (e.g., the 3-phase 480 Vrms AC source), perform suitable conversions, and distribute the power to modules 104.

Although power distribution unit 162 is shown in FIGS. 1b and 1d as immediately adjacent to power connector 158, the flexible cable connection between power distribution unit 162 and power connector 158 may be of any length, so power distribution unit 162 may be placed in any (e.g., convenient, space efficient, etc.) location.

Returning to FIGS. 1d and 1e, network connector 160 may be configured to provide network connectivity for module 104a, such as with other modules within computing system 100, modules in other computing systems and/or any other external computing devices or components. In some embodiments, network connector 160 may include a first interface in communication with a network module configured to perform network interconnection, and a second interface (e.g., shown at 160a in FIG. 1e) in communication with module 104a (e.g., via a module network connector of module 104a, an example of which is shown in FIG. 8 as module network connector 824). In various embodiments, computing system 100 and its networking elements (e.g., network connector 160) may use fiber optic cable and/or electronic cable. In one example, each network connector 160 may interface with a bidirectional fiber optic cable that may include 32 input lines and 32 output lines.

Frame 150 may also include a plurality of frame spacers 152. A frame spacer 152 may include a rack pole hole 157 such that frame spacer 152 may receive rack pole 110 (e.g., as shown in FIG. 1a) through rack pole hole 157. In some embodiments, computing system 100 may include four rack poles 110 and stackable shelf frames 102 that each include four frame spacers 152. However, the number of rack poles and frame spacers per stackable shelf frame may be different in other embodiments. Rack poles 110 may be disposed in parallel with respect to each other to provide a skeletal structure (e.g., of four rack poles 110) for aligning the stackable shelf frames 102 within computing system 100. Once stacked within the skeletal structure, each stackable shelf frame 102 may be movable (e.g., up and down) along length dimension L of rack poles 110, as shown in FIG. 1a.

In some embodiments, stackable shelf frames 102 may be stacked via their frame spacers 152, as shown in FIGS. 1a and 1c. Advantageously, frame spacers 152 may support most or virtually all of the weight of each stackable shelf frame 102 (e.g., as opposed to the more delicate modules 104 and/or cooling elements 106). In some embodiments, conformable TIM may be applied to the top and/or bottom heat-dissipating surfaces of a module, such that when the module is inserted in a stackable shelf frame and the stackable rack-based computing system is in a stacked configuration with no vertical gaps between adjacent frame spacers, the frame spacers may ensure that a precisely calibrated force will be applied to compress the TIM optimally for maximum heat-transfer performance. Frame spacers 152, via their height as shown in FIGS. 1a and 1e, may also be configured to conform to the standard distance of height or P.

In some embodiments, at least one of modules 104 within computing system 100 may be a network module. For example, network module 104c shown in FIG. 1a, which receives only single sided cooling from cooling elements 106, may be a network module (e.g., in embodiments where the network module requires less cooling than other modules). FIGS. 2a and 2b show an example network module 200, configured in accordance with some embodiments. In various embodiments, a network module can provide network interconnection for any number of modules 104 of computing system 100 such that modules 104 may communicate with each other and with external components (e.g., other modules, networks, systems and/or devices). Network module 200 is shown as being configured to support 128 modules 104. As such, network module 200 may be used in computing systems that include up to 128 stackable shelf frames 102 each including a module 104.

For example, network module 200 may include 128 internal network ports IN1-IN128 configured to connect with modules 104 via network connectors 160 of each stackable shelf frame 102. In various embodiments, a network module may further connect each of modules 104 with a plurality of external components. For example, network module 200 may further include 64 external network ports EX1-EX64 configured to interface with external components such as external component 250. In some embodiments, internal network ports IN1-IN128 and external network ports EX1-EX64 may each be configured to interface with bidirectional fiber optic cables 202 and 204 that each include 32 input lines and 32 output lines, as shown in FIG. 2a.

In some embodiments, network module 200 may be configured for passive interconnection where modules 104 may be interconnected with each other and/or with one or more of the external network ports. FIG. 2a shows example output connections 206 and 208 within network module 200 configured to transfer data from module 104 connected with internal network port IN1. As shown, 16 output connections 206 (e.g., from a first 16 of the 32 output lines of fiber optic cable 202) may connect internal network port IN1 to internal network ports IN2-IN17. Furthermore, 16 output connections 208 (e.g., from a second 16 of the 32 output lines of fiber optic cable 202) may further connect internal network port IN1 to external network ports EX1-EX16. In other embodiments, not depicted in FIG. 2a, each of the 32 output lines of fiber optic cable 202 may be connected to any of the ports IN2-IN128 and EX1-EX64, as necessary to produce a specific fixed interconnection topology. Similarly, each of the ports IN2-IN128 may also receive a fiber optic cable 202 connected to a module 104, with each of the cable's 32 output lines connected within module 200 to any of the other internal and/or external network ports.

FIG. 2b shows example input connections 210 and 212 of network module 200 configured to transfer data to module 104 connected with internal network port IN1. As shown, 16 input connections 210 (e.g., routed to a first 16 of the 32 input lines of fiber optic cable 202) may connect internal network ports IN2-IN17 to internal network port IN1. Furthermore, 16 input connections 212 (e.g., from a second 16 of the 32 input lines of fiber optic cable 202) may further connect external network ports EX1-EX16 to internal network port IN1. In other embodiments, not depicted in FIG. 2b, each of the 32 input lines of fiber optic cable 202 may be connected to any of the ports IN2-IN128 and EX1-EX64, as necessary to produce a specific fixed interconnection topology. Similarly, each of the ports IN2-IN128 may also receive a fiber optic cable 202 connected to a module 104, with each of the cable's 32 input lines connected within module 200 to any of the other internal and/or external network ports.

In some embodiments, network module 200 may be configured to perform active switching. For example, network module 200 may include one or more processors configured to programmatically route data to and from the appropriate internal network ports IN1-IN128 and external network ports EX1-EX64. In some embodiments, a set of one or more network modules, each employing passive interconnection and/or active switching, and spanning one or more individual stackable rack-based computing systems, may be interconnected via cables attached to their external network ports. The topology of the resulting network may be a multidimensional torus, hypercube, butterfly, or any other suitable topology. Additionally, in some embodiments, loopback optical plugs may be attached to one or more ports on network module 200 that are unused (e.g., not connected to a cable). Each such plug may provide a passive optical loopback connection between 32 input lines and 32 output lines of a single otherwise-unconnected port, and thereby creates additional usable paths within the network created by network module 200.

FIG. 3 shows a front view of example computing system 100 in an open configuration, in accordance with some embodiments. Computing system 100 may be configured to transform between the open configuration and the stacked configuration. As discussed above, the open configuration refers to a configuration of computing system 100 where a gap is opened between any two stackable shelf frames 102. The gap may be used to provide access to the modules 104, stackable shelf frames 102, cooling elements 106, components of the module, etc. for purposes such as installation, repair, replacement, removal, configuration, troubleshooting, upgrades, or the like.

As shown in FIG. 3, gap 302 may be opened between stackable shelf frames 102a and 102b to provide access to stackable shelf frames 102a and 102b, modules 104a and 104b, cooling elements 106a and 106b, etc. Similar gaps 302 can be opened between any of the other stackable shelf frames. FIG. 4 shows a simplified view of computing system 100 that includes shelf frame 102a and rack poles 110a, 110b, 110c and 110d, in accordance with some embodiments. As shown, each frame spacer (e.g., frame spacers 152a and 152b) of stackable shelf frame 102b may include frame pin holes 402. Furthermore, each rack pole 110a-110d may include numerous pole pin holes 404, such as at least one pole pin hole 404 for each stackable frame shelf of computing system 100 (e.g., 128 pole pin holes 404, or more, for each rack pole to support 128 stackable shelf frames). In some embodiments, the distance between any two pole pin holes 404 of a rack pole 110 may also be configured to conform to the standard distance of height or P. For example, each pole pin hole may be separated by exactly the standard distance of height or P. Rack pin holes 402 and pole pin holes 404 may be configured to receive pin 406. Once received, pin 406 may mechanically couple stackable shelf frame 102b and to a rack pole, such as rack pole 110a. In some embodiments, a pin may be threaded through more than one group of rack pin holes 402 and pole holes 404 to couple a stackable shelf frame to more than one rack pole. For example, stackable shelf frame 102b may be coupled with rack pole 110a and rack pole 110b via pin 406. Similarly, stackable shelf frame 102b may be coupled with rack pole 110c and 110d via one or more pins.

After stackable shelf frame 102b has been mechanically coupled to rack poles 110a-110d, rack poles 110a-110d may be moved (e.g., mechanically) along length dimension L. For example, rack poles 110a-110d may be raised to form gap 302 between stackable shelf frame 102b and stackable shelf frame 102a in the open configuration, as shown in FIG. 3. Stackable shelf frames 102b, above stackable shelf frame 102b, may not be coupled with rack poles 110a-110d via a pin. Instead, these stackable shelf frames may rest on stackable shelf frame 102b (e.g., via their frame spacers) and be moved along with stackable shelf frame 102. Stackable shelf frame 102a, as well as stackable shelf frames 102c below stackable shelf frame 102a, may also not be coupled with rack poles 110a-110d. As such, movement of rack poles 110a-110d does not affect the location of stackable shelf frames 102a and 102c. Similarly, rack poles 110a-110d may be lowered (e.g., from the open configuration) such that gap 302 no longer exists between stackable shelf frame 102b and stackable shelf frame 102a in the stacked configuration.

In some embodiments, rack poles 110a-110d may be configured to move, in unison, via any suitable mechanical means. Rack pole 110a shown in FIG. 4 (as well as the other rack poles), for example, may include a threading 408 and a rotatable bolt 410. Via controlled rotation of rotatable bolt 410, threading 408 of rack pole 110a may cause rack pole 110a to move up or down along length dimension L. In various embodiments, uniform control of the rotatable bolts may be performed by mechanical means (e.g., by hand) electromechanical means (e.g., a motor configured to generate forces that rotate the rotatable bolts) and/or computer implemented means (e.g., a processor executing a software program for controlling the motor).

The use of pins is only one example of suitable means for opening and closing gaps between two stackable shelf frames. For example, some embodiments may utilize one or more wedges that may be removably inserted between frame spacers. In another example, an external service device (e.g., a specialized forklift-type unit) can also be used. In some embodiments, computing system 100 may include bifurcated groups of stackable shelf frames. For example, a first group of stackable shelf frames (e.g., at the top of the stack) may be configured to shift upwards in the open configuration such that a gap may be opened between any of the first group of stackable shelf frames. A second group of stackable shelf frames (e.g., at the bottom of the stack) may be configured to shift downwards in the open configuration such that a gap may be opened between any of the second group of stackable shelf frames. Advantageously, more than one gap can be opened within computing system 100 at a time, via bifurcation.

In some embodiments, cooling elements 106 may be configured to flex or otherwise mechanically adapt to support the adjustability between the open and stacked configuration, as shown for cooling elements 106 and 106b in FIG. 3. For example, cooling elements 106 (e.g., as heat pipes) may include one or more flexible elbow joints and/or may be made of a flexible material. The extent of the flexing of cooling elements 106 in FIG. 3 is exaggerated because of the exaggerated height of computing system 100 as well as for explanatory clarity.

In some embodiments, a stackable rack-based computing system may be configured for efficient addition and/or removal of any stackable shelf frame to/from the computing system. FIG. 5 shows an example stackable shelf frame 500, in accordance with some embodiments. Stackable shelf frame 500 may be similar to stackable shelf frames 102 in many respects that are not repeated to avoid unnecessarily overcomplicating the disclosure. Stackable shelf frame 500 may include U-shaped frame spacers 552, as shown by U-shaped frame spacers 552a, 552b, 552c and 552d. U-shaped spacers 552 may be shaped such that stackable shelf frame 500 can be moved along direction S1 (and/or lifted) to interface with rack poles (e.g., as shown in FIG. 4, except spaced in accordance with the U-shaped frame spacers 552) such that the rack poles are within rack pole U-holes 554. When the rack poles are within the rack pole U-holes 554 of each of U-shaped spacers 552, the stackable shelf frame 500 may be considered added to the computing system. Similarly, stackable shelf frame 500 may be moved in direction S2 (and/or lifted) away from the rack poles and removed from the computing system.

In some embodiments, stackable shelf frame 500 may be configured to receive a pin 506 to mechanically couple to rack poles for movement. As shown, pin 506 may be shaped to support the location of U-shaped spacers 552a and 552b. Furthermore, frame arm 560 may be curved to receive and/or guide pin 506 toward the frame pin hole of U-shaped spacer 552b.

FIG. 6 shows a cross sectional top view of an example computing system 600, in accordance with some embodiments. Computing system 600 may use similar techniques for transitioning between the open and stacked configurations as discussed above for computing system 100, such as frame pin holes and pole pin holes to mechanically couple stackable shelf frames 500 with movable pole pins. Furthermore, when a gap is opened between two stackable shelf frames 500 (e.g., in the open configuration), one or more of the stackable shelf frames 500 may be readily added and/or removed. For example, stackable shelf frame 500 shown in FIG. 6 may be selected for removal from computing system 600. First, cooling elements 506 may be uncoupled from stackable shelf frame 500 and cooling tanks 508. Next, stackable shelf frame 500 may be moved along direction S2 for removal. Once stackable shelf frame 500 is removed, the next stackable shelf frame may be removed in a similar manner, and so forth for each stackable shelf frame below stackable shelf frame 500. Similarly, a stackable shelf frame may be added on top of stackable shelf frame 500 (e.g., via movement along direction S1), the cooling elements may be coupled to the stackable shelf frame and to the cooling tanks, and another stackable shelf frame may be added thereafter, and so forth (e.g., depending on the size of the gap opened and the capacity of computing system 600 in terms of power, cooling, networking, rack pole length, etc.).

In some embodiments, U-shaped spacers 552b and 552c may be coupled closer to frame 550 and U-shaped spacers 552a and 552d may be coupled further to frame 500 than the corresponding features of stackable shelf frame 102a, as shown in FIG. 1d. Rack poles 510a, 510b, 510c and 510d may be disposed accordingly. As such, stackable shelf frame 500 may be removed from and/or added to computing system 600 without, for example, U-shaped spacers 552b and 552c being impeded by rack poles 510a and 510d, respectively, as well as the cooling tanks 508.

In some embodiments, one or more of U-shaped spacers 552a-552d may include anti-sliding elements to prevent the undesired sliding of stackable shelf frame 500 in the stacked configuration. Sliding may occur, for example, along the direction S2 shown in FIG. 6 because of the opened sides of the U-shaped spacers 552a-552d. FIG. 7a shows a magnified view of an example U-shaped spacer 700, in accordance with some embodiments. U-shaped spacer 700 may include one or more raised structures, or “balls,” as used herein, on a first surface. On a second surface opposite the first surface, U-shaped spacer 700 may include one or more correspondingly shaped indents, or “detents,” as used herein. The balls and detents may include corresponding structures, such as hemispheres, that allow the balls and detents of consecutively stacked stackable shelf frames to interface and hold the stackable shelf frames in place. FIG. 7b shows a cross sectional view of U-shaped spacer 700 along line BB, where U-shaped spacer 700 is stacked on top of U-shaped spacer 708. As shown, detent 710 of U-shaped spacer 700 may interface with ball 612 of U-shaped spacer 708 to keep U-shaped spacer 706 more firmly secured on top of U-shaped spacer 708. In various embodiments, any other type of suitable anti-sliding elements may be used. For example, the U-shaped spacers may be held by magnetic elements, such as where each U-shaped spacer may include positive and negative magnetic poles that attract corresponding poles of consecutively stacked U-shaped spacers.

FIG. 8 shows a top view of an example marina brain board assembly 800, configured in accordance with some embodiments. Marina brain board assembly 800 is an example of a module that may be placed within a stackable frame shelf to receive two-sided cooling, such as module 104 shown in FIG. 1a. Other types of module may include virtually any configuration of components (e.g., in terms of number, placement, and/or function of the components) and receive similar two-sided cooling, power, networking, scalability and serviceability, as discussed above in connection with various embodiments of rack-based computing systems. In various embodiments, components in a module may incorporate any number of different types of processes and/or functions, including but not limited to electrical, electronic, optical, mechanical, thermal, chemical, biological, quantum-physical, and/or nuclear processes and/or functions.

Of various compatible configurations, marina brain board assembly 800 may provide enhanced serviceability by separating different potential points of failure into removably interconnected pieces. Marina brain board assembly 800 may include a module frame 802 to which the various components, such as boardwalk board 804 and/or pier boards 810a-810d, may be mounted. Boardwalk board 804 may be configured to provide a functional and mechanical (e.g., attachment) interface for power boards 806a-806d, network switch board 808, and pier boards 810a-810d. For example, boardwalk board 804 may include power connectors 812 to receive power from power boards 806a-806d. In some embodiments, power connectors 812 may be configured to be connectable with any of power boards 806a-806d and/or replacements thereof. Boardwalk board 804 may further include network connector 814 configured to exchange data with network switch board 808.

Boardwalk board 804 may further include pier connectors 816 configured to provide power and data (e.g., as relayed from the power boards 806 or network switch board 808) to pier boards 810a-810d. In some embodiments, pier connectors 816 may be configured to be connectable with any of pier boards 810a-810d and/or replacements thereof.

Each pier board 810a-180d may be configured to provide a functional and mechanical (e.g., attachment) interface for boat lobe boards 818, such as with eight boat lobe boards 810 on each side of a pier board 810. For example, pier board 810a may include a boat connector 820 configured to removably connect to boat lobe board 818a, other boat lobe boards 818, and/or replacements thereof. In some embodiments, each of pier boards 810a-810d may include sixteen boat connectors to connect with sixteen pier boat lobe boards 818. Furthermore, each of the sixteen boat connectors may provide power and networking (e.g., as relayed from one or more power boards 806 and network switch board 808, respectively, via boardwalk board 804) to each of pier boat lobe boards 818.

In some embodiments, boardwalk board 804 and/or pier boards 810a-810d may be physically mounted to module frame 802 while power boards 806a-806d, network switch board 808 and/or boat lobe boards 818 may be physically mounted to marina brain board assembly 800 only via boardwalk board 804 or pier boards 810a-810d. As such, a failure in any of the processing, power and networking components may be efficiently remedied with replacement components without excessive waste (e.g., of other integrated but working components). For example, a broken boat lobe board 804 may be removed via the connectors and a replacement boat lobe board 804 may be attached without disturbing the function of the other boat lobe boards 804.

FIG. 9a shows a top view of an example boat lobe board 900 and FIG. 9b shows a cross sectional view of boat lobe board 900 taken along line CC in FIG. 9a, configured in accordance with some embodiments. Boat lobe board 900 may include PCB 902, which may be double sided and include components disposed on each side, as shown in FIG. 9b. Some example components may include processing component 904, memory/storage components 906, and boat power converter component 908. Components may be mounted to PCB 902 singly and/or 3D-stacked, via Through-Silicon Via (TSV) and/or other stacking techniques. Boat lobe board 900 may include a processing component 904, four memory/storage components 906, and one power converter component 908 on each side of PCB 902. Boat lobe board 900 may further include a pier connector 910 configured to removably connect with a boat connector 820 of a boat lobe board 818, as shown in FIG. 8 to provide power and networking to boat lobe board 818. Accordingly, pier connector 910 may include a network connector 912 and a power connector 914.

In some embodiments, the components on each side of PCB 902 may form a discrete set of computing resources. With respect to FIG. 9a, processing component 904 may include processing circuitry that for example, may execute instructions stored in memory/storage components 906 to perform various computing functions. For example, processing component 904 may be a 64 bit system-on-chip (SoC) processor. Furthermore, processing component 904 may include integrated networking interface(s) connected with network connector 912 (e.g., via PCB 902) or alternatively, one or more networking interface components may be included in boat lobe board 818 as an intermediary to provide the networking interface. Memory/storage components 906 may provide persistent and/or volatile storage. For example, memory/storage components 906 may include dynamic random-access memory (DRAM), persistent Flash storage (e.g., NAND), and/or combinations of persistent and volatile storage. Boat power converter 908 may be configured to convert 48 V DC received at power connector 914 into a power source in the range of 1 V DC that may be provided to each of processing component 904 and memory/storage components 906. In some examples, the approximately 1 V DC power source may be an approximately 10 A and 10 W power source.

Returning to FIG. 8, marina brain board assembly 800 may further include module power connector 822 and module network connector 824. As discussed above, module power connector 822 may be connected with the power distribution unit (e.g., power distribution unit 162 shown in FIGS. 1b and 1d) via a power connector of a stackable shelf frame (e.g., power connector 158 of stackable shelf frame 102a, as shown in FIG. 1d). Module power connector 822 may further be connected with each of power boards 806a-806d. As such, each of power boards 806a-806d may be configured to transform a 1-phase 277 Vrms AC voltage from the power distribution unit into a 48 V DC source. As discussed above, the 48 V DC source may then be converted (e.g., at the boat lobe board level) by each boat power converter 908 into an approximately 1 V DC power source that may be provided to processing components 904 and memory components 906 of the boat lobe boards 818.

In some embodiments, each of power boards 806a-806d may be configured to transform a 1-phase 277 Vrms AC voltage from the power distribution unit into an approximately 1 V DC power source (e.g., at 10 A and 10 W) that may be provided to each of processing components 904 and memory components 906 of the boat lobe boards 818. Here, the boat lobe boards 818 may not include boat power converters 908.

In some embodiments, boardwalk board 804 may be configured to control the distribution of power from power boards 806a-806d to pier boards 810a-810d. For example, each of power boards 806a-806d may be connected with one of the pier boards 810a-810. In another example, pier boards 810a-810d may each share power distributed from one or more of power boards 806 on a regular basis and/or in the event of a failure on one or more of power boards 806. As such, failure of a power board 806 may not necessarily cause all 16 boat lobe boards 818 of a pier board 810 to lose power.

Also as discussed above, module network connector 824 may be connected with a network module (e.g., network module 200 shown in FIGS. 2a and 2b) via a network connector of the stackable shelf frame (e.g., network connector 160 for stackable shelf frame 102a, as shown in FIG. 1d). Module network connector 824 may be further connected with network switch board 808. Network switch board 808 may be configured to process the incoming data from the network module (e.g., from the 32 input lines of fiber optic cable 202 shown in FIG. 2a) and to send the incoming data to boardwalk board 804 for routing to the appropriate pier board 810, and then routing by the pier board to the appropriate boat lobe board 818 via a boat connector 820. Network switch board 808 may be further be configured to process the outgoing data to the network module received from boat lobe boards 818 via their boat connectors 820, pier board 810 and boardwalk board 804. For example, network switch board 808 may be configured to send the outgoing data to other modules and/or external components (e.g., by sending data to the appropriate line of the 32 output lines of fiber optic cable 202 shown in FIG. 2a).

FIG. 10 shows a cross sectional view of computing system 100 taken along line AA shown in FIG. 1a and including a marina brain board assembly 800 disposed therein, in accordance with some embodiments. Module frame 802 may be fit within frame 150 of stackable shelf frame 102a to mechanically stabilize marina brain board assembly 800 within stackable shelf frame 102a. Module power connector 822 may be connected to power connector 158 and module network connector 824 may be connected with network connector 160. Furthermore, the bottom of marina brain board assembly 800 (e.g., including components disposed on the bottom of lobe boat boards 818, pier boards 810a-810d, power boards 806a-806d, marina board 804 and/or network switch board 808 may be in physical and thermal contact with cooling elements 106a to provide cooling to marina brain board assembly 800.

FIG. 11 shows a top view of an example marina brain board assembly 1100, configured in accordance with some embodiments. Marina brain board assembly 1100 may include module frame 1102 and marina board 1104. Marina board 1104 may be configured to perform power and networking routing functions as described above for boardwalk board 804. For example, marina board 1104 may be a PCB that includes power components 1106a-1106d, which may be configured to perform similar functions as those described above with respect to power boards 806a-806d, respectively. Marina brain board 1104 may also include network component 1108, which be configured to perform similar functions with those described above with respect to network switch board 808. Unlike marina brain board assembly 800, marina brain board assembly 1100 sacrifices individual serviceability of components that perform power conversion and network switching. For example, if network switch board 808 and/or one or more power components 1106a-1106d fail, marina board 1104 may need to be replaced in its entirety. In exchange for the loss in serviceability, marina brain board assembly 1100 may be cheaper (e.g., in up-front manufacturing costs) and/or more space efficient (e.g., by utilizing integrated connections of components on PCB rather than connectors).

FIG. 12 shows a top view of an example brain board assembly 1200, configured in accordance with some embodiments. Brain board assembly 1200 may include frame 1202 and brain board 1204 that includes power components 1206a-1206d and network component 1208, which may be similar to power components 1106a-1106d and network component 1108 of marina board 1104 shown in FIG. 11. Brain board 1204 may further include (e.g., integrated to the PCB) brain power connector 1208 and brain network connector 1210, configured to connect with a power connector and a network connector of a stackable shelf frame (e.g., similar to module power connector 822 and module network connector 824 of marina brain board 800, as described above in connection with FIG. 8). As such, wiring in brain board assembly 1200 may be reduced relative to marina brain board assemblies 800 and 1100.

Furthermore, brain board assembly 1200 may not include the pier boards and boat lobe boards of marina brain board assemblies 800 and 1100. Instead, brain board assembly 1200 may include a lobe board 1212, which may be two sided PCB. Sixty four lobe components 1214 may be disposed on each side of lobe board 1208 for a total of 128 lobe components 1214. In some embodiments, each lobe component 1214 may include a processing component and one or more (e.g., four) memory components. The use of a single lobe board 1212 instead of multiple pier boards and boat lobe boards may reduce the serviceability of brain board assembly 1200 (e.g., relative to marina brain board assemblies 800 and 1100) while providing lower upfront manufacturing costs.

In some embodiments, one or more cooling tanks may be placed on the back of a stackable rack-based computing system (e.g., instead of at the sides as shown in FIGS. 1a, 1b and 1c). FIG. 13 shows a cross sectional top view of an example computing system 1300, in accordance with some embodiments. Cooling tank 1308 may be used as a “thermal backplane” in which the liquid condensing portions 1320 of heat pipes 1306 of stackable shelf frame 1302, as well as other stackable shelf frames, may be inserted for cooling. Stackable shelf frame 1302 may be added and/or removed from computing system 1300 while cooling elements 1306 remain coupled to stackable shelf frame 1302. In some embodiments, power distribution unit 1362 may be located at a side or some other area of computing system 1300 to make room for the thermal backplane.

In some embodiments, the one or more cooling elements of each stackable shelf frame may be cooling plates rather than heat pipes. FIG. 14 shows a cross sectional top view of an example computing system 1400, in accordance with some embodiments. As shown, cooling plate 1406 may be mechanically coupled with stackable shelf frame 1402 (e.g., instead of heat pipes and/or cooling tanks). Cooling plate 1406 may include cooling fluid distribution nodes 1408 and 1410, which are connected to coolant inlet 1412 and coolant outlet 1414, respectively. In some embodiments, coolant inlet 1412 may input cooling fluid (e.g., from another cooling plate disposed above cooling plate 1406 and/or from an external cooling source, manifold, and/or pump) to cooling plate 1406 and coolant outlet 1414 may output cooling fluid from cooling plate 1406 (e.g., and to another cooling plate disposed below cooling plate 1406 and/or to an external cooling source, manifold, and/or pump). In some embodiments, coolant inlet 1412 and/or coolant outlet 1414 may be connected with other cooling plates. The connections between cooling plates may include flexible material, such as tubes, to facilitate the adjustment of the stackable shelf frames between the open and stacked configurations. Cooling plate 1406 may internally include channels (e.g., parallel-flow microchannels; not shown) that facilitate coolant flow between the coolant distribution nodes 1408 and 1410 to cool each side of cooling plate 1406. Additional details regarding cooling plates, applicable to some embodiments, are discussed in greater detail in U.S. Patent Publication No. 2012/0020024, titled “Cooled Universal Hardware Platform,” which is hereby incorporated by reference in its entirety.

In some embodiments, one or more of the rack poles may include a pressure element that pushes stacked stackable shelf frames against each other. FIG. 15 shows an example computing system 1500, in accordance with some embodiments. Rack pole 1510 may be attached to a pressure element that includes rack cap 1512 and spring 1514. The force of spring 1514 compressed against the top of rack cap 1512 causes rack cap 1452 to exert a downwards force against stackable shelf frames 1502. This downwards force may help ensure that the frame spacers of all stackable shelf frames 1502 are all held together tightly under all conditions (e.g., without relying exclusively on gravity). For example, the topmost stackable shelf frame 1502 does not have the weight of a stackable shelf frame 1502 above, to help provide a downward force. As another example, some embodiments might be subject to operational conditions where gravity cannot be relied on to hold the stackable shelf frames together, e.g. when operating in an aircraft avionics bay during a 90 degree banking turn. In embodiments where conformable TIM is applied to the top and/or bottom heat-dissipating surfaces of modules, the pressure element also helps provide the force needed to fully compress all TIM layers, and thereby eliminate any vertical gaps between adjacent frame spacers. Furthermore, some embodiments may include one or more panels that provide additional protection. Top panel 1516 and side panels 1518 and 1520, for example, may be disposed at the top and sides of computing system 1500. Although not shown in FIG. 15, computing system 1500 may further include a bottom panel, back panel and/or front panel.

Many modifications and other embodiments will come to mind to one skilled in the art to which these embodiments pertain having the benefit of the teachings presented in the foregoing descriptions and the associated drawings. Therefore, it is to be understood that embodiments and implementations are not to be limited to the specific example embodiments disclosed and that modifications and other embodiments are intended to be included within the scope of the appended claims. Although specific terms are employed herein, they are used in a generic and descriptive sense only and not for purposes of limitation.

1. A stackable rack-based system, comprising:
a plurality of stackable shelf frames, each stackable shelf frames including:
a module including a top side and a bottom side;
one or more cooling elements thermally coupled to one of the top side and the bottom side of the module; and
a frame configured to mechanically couple the module and the one or more module cooling elements; and
wherein:
the plurality of stackable shelf frames is adjustable between a stacked configuration and an open configuration;
a module of a stackable shelf frame of the plurality of stackable shelf frames is thermally coupled with cooling elements at the top side and the bottom side of the module in the stacked configuration; and
a gap is open between any two of the plurality of stackable shelf frames in the open configuration.

2. The stackable rack-based system of claim 1, wherein:
each of the plurality of stackable shelf frames includes two or more frame spacers; and
the plurality of stackable shelf frames are stacked on top of each other via the two or more frame spacers of each of the plurality of stackable shelf frames in the closed configuration.

3. The stackable rack-based system of claim 2, the two or more frame spacers of each of the plurality of stackable shelf frames each conform to a standard distance of height.

4. The stackable rack-based system of claim 2, further comprising two or more rack poles each received by a rack pole hole of one of the two or more frame spacers of each of the plurality of stackable shelf frames.

5. The stackable rack-based system of claim 4, wherein the two or more rack poles may uniformly move along a length dimension L of the two or more rack poles.

6. The stackable rack-based system of claim 5, wherein each of the plurality of stackable shelf frames may be mechanically coupled to the two or more rack poles such that movement of the two or more rack poles also moves a mechanically coupled stackable shelf frame of the plurality of stackable shelf frames, thereby adjusting the plurality of stackable shelf frames between the stacked configuration and the open configuration.

7. The stackable rack-based system of claim 6, wherein:
the two or more rack poles include pole pin holes for receiving a pin;
each of the two or more frame spacers of each of the plurality of stackable shelf frames includes frame pin holes for receiving the pin.

8. The stackable rack-based system of claim 7, wherein a distance between any two of the pole pin holes conforms to a standard distance of height.

9. The stackable rack-based system of claim 2, wherein each of the two or more frame spacers of at least one of the plurality of stackable shelf frames are U-shaped spacers.

10. The stackable rack-based system of claim 1, wherein the cooling elements are selected from the group of heat pipes and cooling plates.

11. The stackable rack-based system of claim 1 further comprising one or more cooling tanks thermally coupled to the cooling elements.

12. The stackable rack-based system of claim 1, wherein at least one module of a stackable shelf frame of the plurality of shelf frames is a networking module configured to provide at least one of passive network interconnection and active network switching for other modules of the plurality of stackable shelf frames.

13. The stackable rack-based system of claim 1, wherein the module is a marina brain board assembly.

14. The stackable rack-based system of claim 1, wherein:
the module includes one or more two-sided printed circuit boards that defines the top side and the bottom side of the module; and
one or more components are disposed on each side of the one or more two-sided printed circuit boards and thermally coupled with cooling elements at the top side and the bottom side of the module in the stacked configuration.

15. The stackable rack-based system of claim 14, wherein the one or more components disposed on each side of the one or more two-sided printed circuit boards are in physical contact with the cooling elements at the top side and the bottom side of the module in the stacked configuration.

16. The stackable rack-based system of claim 14, wherein the one or more two-sided printed circuit boards are one or more boat lobe boards removably connected with a pier board for power and networking.

17. The stackable rack-based system of claim 1, wherein the module includes a boardwalk board and a network switch board configured to provide network functionality to the module, the network switch board removably connected to the module via the boardwalk board.

18. The stackable rack-based system of claim 1, wherein the module includes a boardwalk board and a boardwalk power board configured to provide power to the module, the boardwalk power board removably connected to the module via the boardwalk board.

19. A stackable rack-based system, comprising:
a plurality of stackable shelf frames, each including:
a module including a two-sided printed circuit board, the two-sided printed circuit board defining a top side and a bottom side of the module;
a cooling element thermally coupled to one of the bottom side and the top side of the module; and
two or more frame spacers each including a rack pole hole; and
two or more rack poles, each within the rack pole hole of a respective one of the two or more frame spacers of each of the plurality of stackable shelf frames such that:
the two or more rack poles may move independently of the plurality of stackable shelf frames; and
the two or more rack poles can be mechanically coupled to one or more of the plurality of stackable shelf frames such that the one or more of the plurality of stackable shelf frames move with the two or more rack poles.

20. A stackable rack-based system, comprising:
a plurality of stackable shelf frames each including:
a module including a two-sided printed circuit board, the two-sided printed circuit board including a top side and a bottom side of the module;
one or more heat pipes thermally coupled to one of the bottom side and the top side of the module;
two or more frame spacers each including a rack pole hole; and
a cooling tank thermally coupled to the heat pipes; and
two or more rack poles, each within the rack pole hole of a respective one of the two or more frame spacers of each of the plurality of stackable shelf frames, wherein the two or more rack poles can be mechanically coupled to one or more of the plurality of stackable shelf frames such that the one or more of the plurality of stackable shelf frames move with the two or more rack poles.

21. The stackable rack-based system of claim 1, wherein the module of the stackable shelf frame includes computing components.

22. The stackable rack-based system of claim 11, wherein each of the one or more cooling tanks and each of the plurality of stackable shelf frames conform to a standard distance of height.
